(19) United States
(12) Patent Application Publication
(10) Pub. No.: US 2007/0009267 A1
(43) Pub. Date: Jan. 11, 2007

(54) Driving a laser using an electrical link driver

(76) Inventors: Darren S. Crews, Santa Clara, CA (US); Shenggao Li, Pleasanton, CA (US); Chien-Chang Liu, Sunnyvale, CA (US); Robert J. Johnston, Sacramento, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/165,298

(22) Filed: Jun. 22, 2005

(51) Int. Cl. H04B 10/04

(52) U.S. Cl. 398/182

(57) ABSTRACT

An electrical link driver for a point-to-point link is coupled to a laser. The electrical link driver provides a modulation current to the laser.

### BACKGROUND

1. Field

Embodiments of the invention relate to the field of optics and more specifically, but not exclusively, to driving a laser using an electrical link driver.

2. Background Information

Optical signals may be used to send data between devices. A data signal is used to modulate a laser output for transmission over an optical fiber. In today's systems, a laser is driven by a laser driver customized for that particular laser.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating driving a laser using an electrical link driver in accordance with one embodiment of the present invention.

FIG. 2A is a block diagram illustrating a computer system having point-to-point links in accordance with one embodiment of the present invention.

FIG. 2B is a block diagram illustrating a point-to-point link in accordance with one embodiment of the present invention.

FIG. 2C is a flowchart illustrating a point-to-point link in accordance with one embodiment of the present invention.

FIG. 3 is a block diagram illustrating an apparatus to drive a laser using an electrical link driver in accordance with one embodiment of the present invention.

FIG. 4 is a flowchart illustrating the logic and operations of driving a laser using an electrical link driver in accordance with one embodiment of the present invention.

FIG. 5A is a block diagram illustrating a test setup to drive a laser using an electrical link driver in accordance with one embodiment of the present invention.

FIG. 5B is an eye diagram of a modulation signal to drive a laser using an electrical link driver in accordance with one embodiment of the present invention.

FIG. 5C is an eye diagram of the laser output of a laser driven by an electrical link driver in accordance with one embodiment of the present invention.

FIG. 6 is a block diagram illustrating one embodiment of a computer system to implement embodiments of the present invention.

### DETAILED DESCRIPTION

In the following description, numerous specific details are set forth to provide a thorough understanding of embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring understanding of this description.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

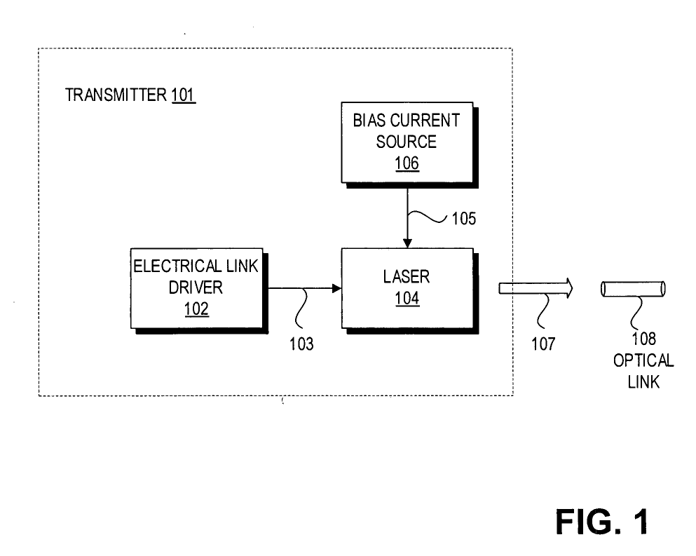

Turning to FIG. 1, an embodiment of a transmitter 101 is shown. Transmitter 101 includes an electrical link driver 102 coupled to a laser 104 to provide a modulation current 103 to laser 104. Transmitter 101 also includes a bias current source 106 to provide a bias current 105 to laser 104. In an alternative embodiment, bias current 105 may be received from a source outside of transmitter 101. A modulated optical output 107 of laser 104 is optically coupled to an optical link 108.

In one embodiment, optical link 108 includes one or more optical fibers. In one embodiment, an optical fiber may be integrated with transmitter 101 leaving a pigtail that may be connected to an optical fiber. In another embodiment, transmitter 101 includes a connection port for receiving an optical fiber. In yet another embodiment, transmitter 101 may be part of a transceiver for sending and receiving optical signals along an optical link.

Electrical link driver 102 includes a driver used to drive a point-to-point link that transmits data using electrical signals. In a point-to-point topology, a source is interconnected with a destination using a link. Devices in a point-to-point link have at dedicated connection to each other. Multiple devices do not cooperatively share a transmission path, as in a bus configuration. Embodiments of electrical link driver 201 include a Peripheral Component Interconnect Express (hereafter referred to as “PCIe”) driver, a Serial Advanced Technology Attachment (SATA) driver, or the like. Details regarding PCIe and SATA will be discussed below.

Embodiments of laser 104 include a semiconductor laser diode, such as a Vertical Cavity Surface Emitting Laser (VCSEL), a Fabry Perot (FP) laser, a Distributed Feedback (DFB) laser, a Light Emitting Diode (LED), a Resonant Cavity LED (RCLED), or the like. In semiconductor laser diodes, coherent optical output may be generated when the laser current is maintained above a threshold value. Typically, when a laser diode is used in fast switching applications, the laser diode may be biased slightly above the threshold to avoid turn-on delay. A bias current is used to keep the laser diode above its threshold level and into the laser's linear operating region. In one embodiment, the laser output is modulated by switching the laser output power level between a high value and a low value. These high and low optical output levels may be interpreted as logical 1's and 0's by the receiving device.

In one embodiment, the point-to-point link driven by electrical link driver 102 uses differential signaling to send data between the ends of the link. Differential signaling involves differential drivers and receivers at each end of the point-to-point link. A differential signal uses the difference in voltage between two conductors to transmit logical 1's and 0's. A differential signal includes a voltage on a positive terminal D+ and a negative terminal D−. The differential voltage may be defined as the difference of the positive voltage and the negative voltage. For example, a positive voltage difference between a D+ terminal and a D− terminal may indicate a logical ‘1’, while a negative difference may indicate a logical ‘0.’ No voltage difference between a pair of signals may indicate the point-to-point link is in an off state.

In the embodiment of FIG. 1, laser 104 is driven be electrical link driver 102 instead of by a conventional laser driver. Electrical link driver 102 may be used to drive laser 104 without modifications of electrical link driver 102. The same physical layer that drives a metal transmission line, such as a copper line, may also drive a laser. Thus, in accordance with embodiments described herein, an electric link driver intended for driving an electric link may be used to drive a laser for transmissions over an optical link.

It will also be appreciated that embodiments of the invention may use a standardized “off the shelf” electrical link driver to drive a laser instead of a customized laser driver. In one embodiment, electrical links coming off of a motherboard where a copper cable is normally used may be replaced by an optical fiber using embodiments described herein.

Bypassing the use of a laser driver provides power savings to a system because of no need to provide power to a laser driver as well as an electrical link driver. Optical links are superior to metal conductors because of lighter weight, reduced electromagnetic interference, and longer cable length capabilities. Further, without a laser driver, costs associated with fabrication and testing of transmitter 101 are reduced.

In one embodiment, electrical link driver 102 may include a SATA driver. Embodiments herein having a SATA driver may be substantially in compliance with the SATA specification (Serial ATA: High Speed Serialized AT Attachment, Revision 1.0a, Jan. 7, 2003). SATA uses a first serial path to transmit data, and a second serial path to return acknowledgements to the sender. Each signal path uses a 2-wire differential signaling pair resulting in 4 signal lines per channel. SATA may transmit data at 1.5 Gigabits per second or faster. In accordance with the SATA specification, the voltage swing of a SATA link is approximately 0.125 Volts (V) about the common-mode voltage with a minimum common-mode voltage of about 0.25 V.

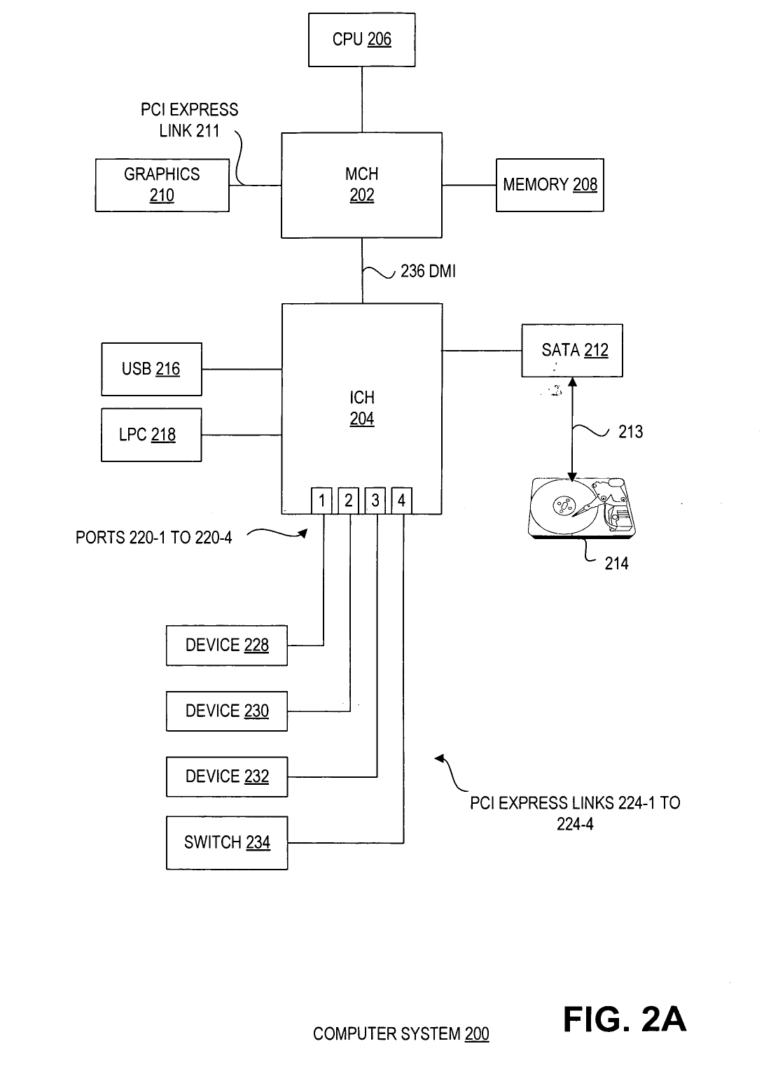

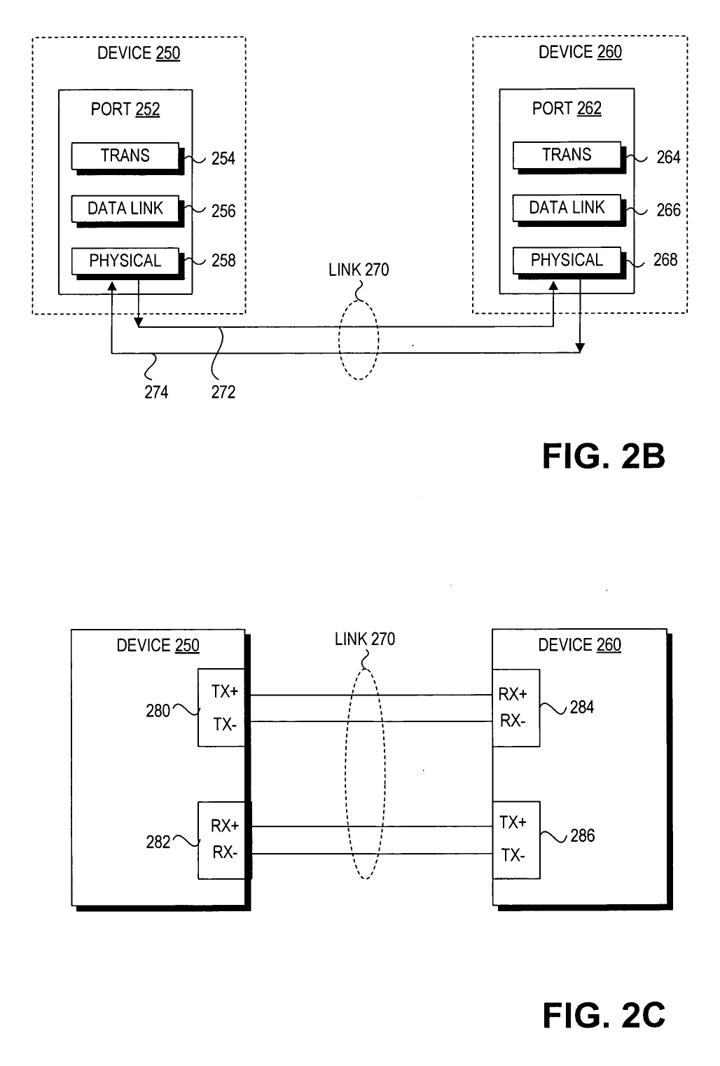

Turning to FIGS. 2A-2C, details regarding PCIe will be discussed in accordance with the PCI Express Base Specification Revision 1.0a, Apr. 15, 2003 (hereafter referred to as the “PCIe specification”). While embodiments of the present invention include a PCIe driver, it will be understood that embodiments of the invention are not limited to a PCIe driver. PCIe may be used in various applications including chip-to-chip connections, add-in card connections, and connections between a board and a device using a cable. While embodiments of the present invention using PCIe are described below in conjunction with an Input/Output Controller Hub (ICH), it will be understood that embodiments herein are not limited to use with an ICH.

Referring to FIG. 2A, one embodiment of a computer system 200 is shown. Embodiments of computer system 200 include, but are not limited to, a desktop computer, a notebook computer, a server, a personal digital assistant, a network workstation, or the like. Computer system 200 includes an I/O controller, such as Input/Output Controller Hub (ICH) 204, coupled to a memory controller, such as Memory Controller Hub (MCH) 202. In one embodiment, ICH 204 is coupled to MCH 202 via a Direct Media Interface (DMI) 236. In one embodiment, MCH 202 and ICH 204 together make up at least a portion of a chipset of computer system 200. In yet another embodiment, ICH 204 includes an Intel® ICH family of I/O controllers.

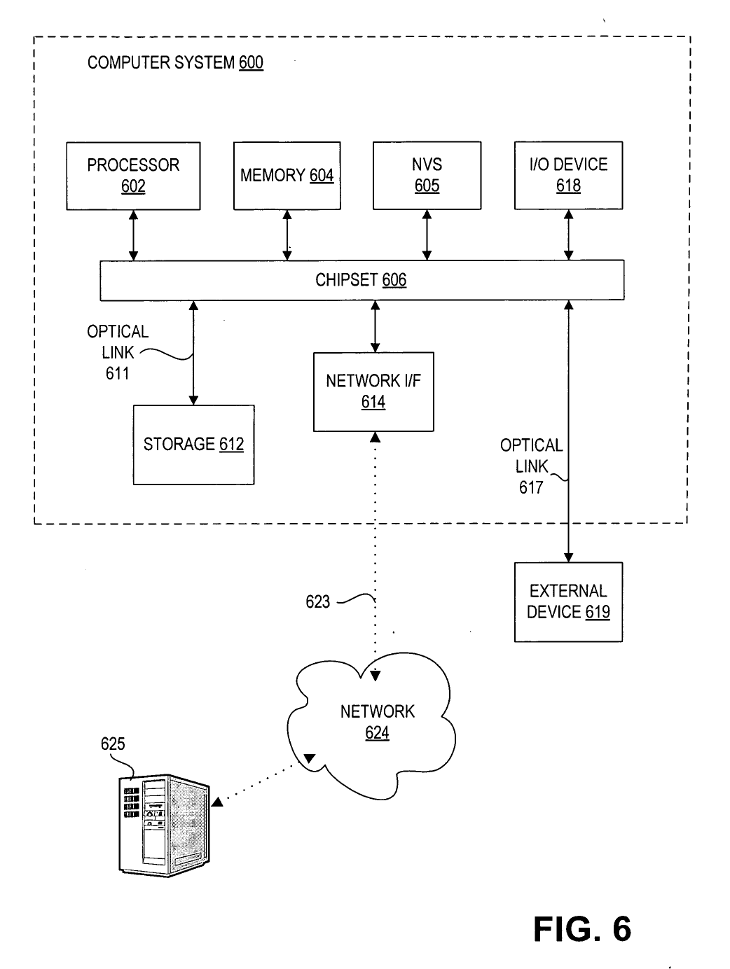

A Central Processing Unit (CPU) 206 and memory 208 are coupled to MCH 202. Embodiments of CPU 206 and memory 208 are discussed below in conjunction with FIG. 6. MCH 202 may also be coupled to a graphics card 210 via a PCIe link 211. In an alternative embodiment, graphics card 210 may be connected to MCH 202 via an Accelerated Graphics Port (AGP) (not shown).

ICH 204 may include support for a SATA interface 212, a Universal Serial Bus (USB) 216, and a Low Pin Count (LPC) bus 218. FIG. 2 also shows a SATA hard disk drive 214 coupled to SATA interface 212 via an optical link 213. SATA interface 212 and hard disk drive 214 may each include embodiments of the present invention to drive a laser using a SATA driver.

ICH 104 may also include PCIe ports 220-1 to 220-4. While the embodiment shown in FIG. 2A shows an I/O controller having four PCIe ports, it will be understood that embodiments of the present invention are not limited to an I/O controller having four PCIe ports.

Each port 220 is coupled to a device via PCIe links 224. In the embodiment of FIG. 2A, port 220-1 is coupled to device 228 by link 224-1, port 220-2 is coupled to device 230 by link 224-2, port 220-3 is coupled to device 232 by link 224-3, and port 220-4 is coupled to a switch 234 by link 224-4. Switch 234 may provide additional PCIe ports for connecting additional devices.

Devices 228, 230, and 232 and switch 234 may be coupled to ICH 204 using expansion card connections or cable connections. Embodiments of the present invention may be used with links 224. Embodiments of devices 228, 230, and 232 include internal devices and external devices.

Turning to FIG. 2B, a device 250 is coupled to a device 260 by PCIe Link 270. Link 270 is a connection between port 252 of device 250 and port 262 of device 260. Link 270 includes a differential signal pair having a receive pair 274 and a transmit pair 272, where transmit and receive are from the perspective of device 250.

Link 270 supports at least 1 lane. Each lane represents a set of differential signaling pairs, one pair for transmitting and one pair for receiving resulting in a total of 4 signals. For example, a x1 link includes 1 lane, and a x4 link includes 4 lanes. The width of link 270 may be aggregated using multiple lanes to increase the bandwidth of the connection between device 250 and device 260. In one embodiment, link 270 may include a x1, x2, x4, x16, or x32 link. In one embodiment, a single lane in one direction has a rate of 2.5 Gigabits per second. Through aggregation of lanes, a x32 link may transmit 10 Gigabytes per second (GB/sec) in each direction.

FIG. 2B also shows the logic layers of an embodiment of the PCIe architecture. Port 252 uses a Transaction Layer 254, a Data Link Layer 256, and a Physical Layer 258. Port 262 uses a corresponding Transaction Layer 264, Data Link Layer 266, and Physical Layer 268.

Information between devices is communicated using packets. To send a packet, the packet is started at the Transaction Layer and passed down to the Physical Layer. The packet is received at the Physical Layer of the receiving device and passed up to the Transaction Layer. The packet data is extracted from the packet at the receiving device.

Referring to FIG. 2C, further details of the physical layer of link 270 is shown. Device 250 includes a PCIe driver 280 for transmitting data across link 270 to a receiver 284 of device 260. Similarly, device 260 includes a PCIe driver 286 for sending data to a receiver 282 of device 250. In accordance with the PCIe specification, transmitters use a differential peak-peak output voltage between 0.8 and 1.2 V and a common mode voltage between 0 and 3.6 V.

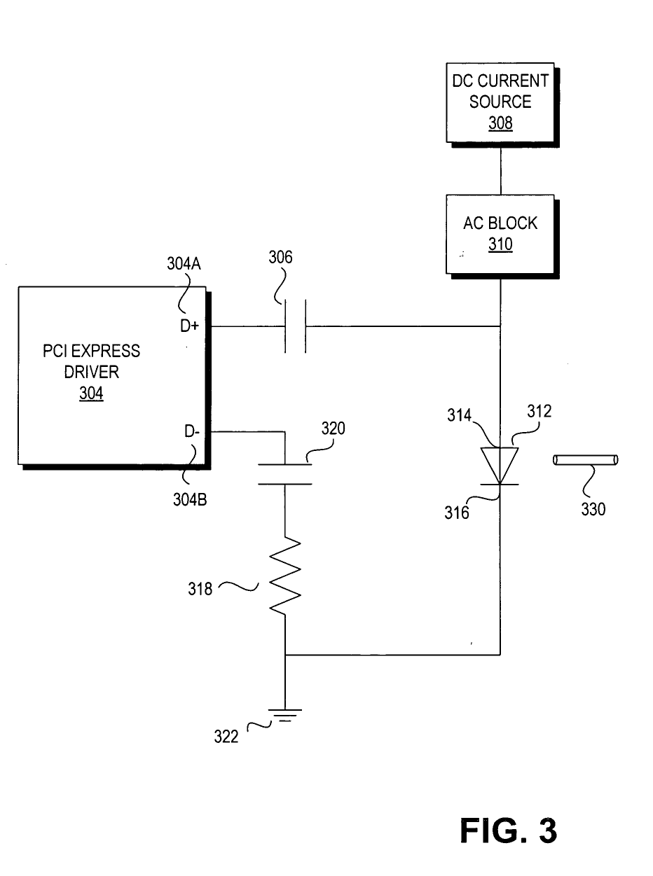

Turning to FIG. 3, an embodiment of the present invention is shown. A PCIe driver 304 includes a positive voltage terminal (D+) 304A and a negative voltage terminal (D−) 304B. Positive terminal 304A is coupled to an Alternating Current (AC) coupling capacitor 306. AC coupling capacitor 306 is coupled to an anode 314 of VCSEL 312.

A Direct Current (DC) current source 308 is coupled to an AC block 310 which in turn is coupled to anode 314. DC current source 308 provides a bias current for VCSEL 312. The optical output of VCSEL 312 is optically coupled to an optical link 330. Embodiments of optical link 330 include an optical fiber, or other types of waveguides, such as a polymer waveguide.

A cathode 316 of VCSEL 312 is coupled to ground 322. Ground 322 is also coupled to a termination resistor 318. In one embodiment, resistor 318 has a resistance of 50 Ohms. Resistor 318 is coupled to an AC coupling capacitor 320 which in turn is coupled to negative terminal 304B of PCIe driver 304.

In an alternative embodiment, VCSEL 312 is situated such that anode 314 is coupled to termination resistor 318 and cathode 316 is coupled to AC coupling capacitor 306.

PCIe driver 304 provides the modulation current to VCSEL 312. In the embodiment of FIG. 3, PCIe driver 304 drives VCSEL 312 single ended, that is, VCSEL 312 is driven by positive terminal 304A and negative terminal 304B is terminated to ground 322.

AC coupling capacitor 306 is used to isolate the DC voltage levels of PCIe driver 304 and the VCSEL 312. In one embodiment, the forward voltage of VCSEL 312 is greater than the allowable common mode voltage of PCIe driver 304. In one embodiment, the forward voltage of VCSEL 312 is approximately 2.0 V±10% while the PCIe driver outputs a 1.0 V signal.

Further, the PCIe specification calls out AC coupling at transmitters of each lane of a link. The PCIe specification denotes an AC coupling capacitance between 75 nanoFarads (nF) and 200 nF. AC coupling capacitor 306 also brings embodiments of the invention within compliance with the PCIe specification. Alternative embodiments of the invention may use DC coupling between an electrical link driver and a laser.

DC current source 308 may provide bias current for VCSEL 314. In one embodiment, DC current source 308 may include circuitry packaged with the PCIe driver 304 either on the same chip as PCIe driver 304 or on a separate chip. In another embodiment, DC current source 308 may include a chip packaged separately from PCIe driver 304.

In one embodiment, AC block 310 may shield the modulation signal of terminal 304A from any parasitics that are associated with DC current source 308 and any related connections of DC current source 308. For example, DC current source 308 may have a lot of parasitic capacitance, so it is desirable to isolate DC current source 308 from the modulation signal. In another example, DC current source 308 is isolated from the modulation signal because variations of the DC voltage of the DC current source 308 may affect the DC current delivered.

As described above, negative output 304B of PCIe driver 304 is coupled to ground 322 through AC coupling capacitor 320 and termination resistor 318. Termination resistor 318 gives PCIe driver 304 a balanced load along with VCSEL 312. In one embodiment, AC coupling capacitor 320 leaves the common mode output of PCIe driver 304 undisturbed.

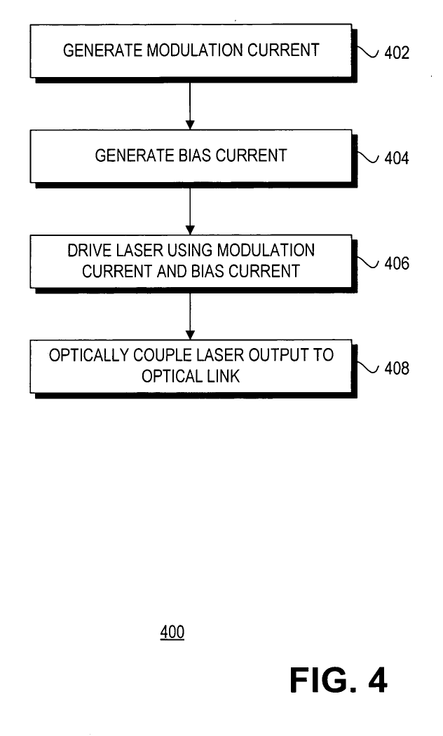

Turning to FIG. 4, a flowchart 400 of the logic and operations of driving a laser with an electric link driver for a point-to-point link is shown. Starting in a block 402, the modulation current is generated. In one embodiment, generating the modulation current includes adjusting the voltage of the modulation current to be compatible with the forward voltage of the laser. In one embodiment, AC coupling capacitor 306 serves to isolate the common mode voltages of the PCIe driver 304 and VCSEL 312. In an alternative embodiment, an AC coupling capacitor may not be needed if the electrical link driver's common mode voltage can match the VCSEL's common mode voltage.

Continuing to a block 404, a bias current is generated. In one embodiment, the generating the bias current includes isolating a bias current source from the modulation current.

Proceeding to a block 406, the laser is driven using the modulation current and the bias current. In one embodiment, driving the laser includes providing the electric link driver a balanced load. In the embodiment of FIG. 3, giving the electric link driver a balance load includes termination resistor 318 coupled between negative voltage terminal 304B and ground 322. In a block 408, the optical output of the laser is optically coupled to an optical link.

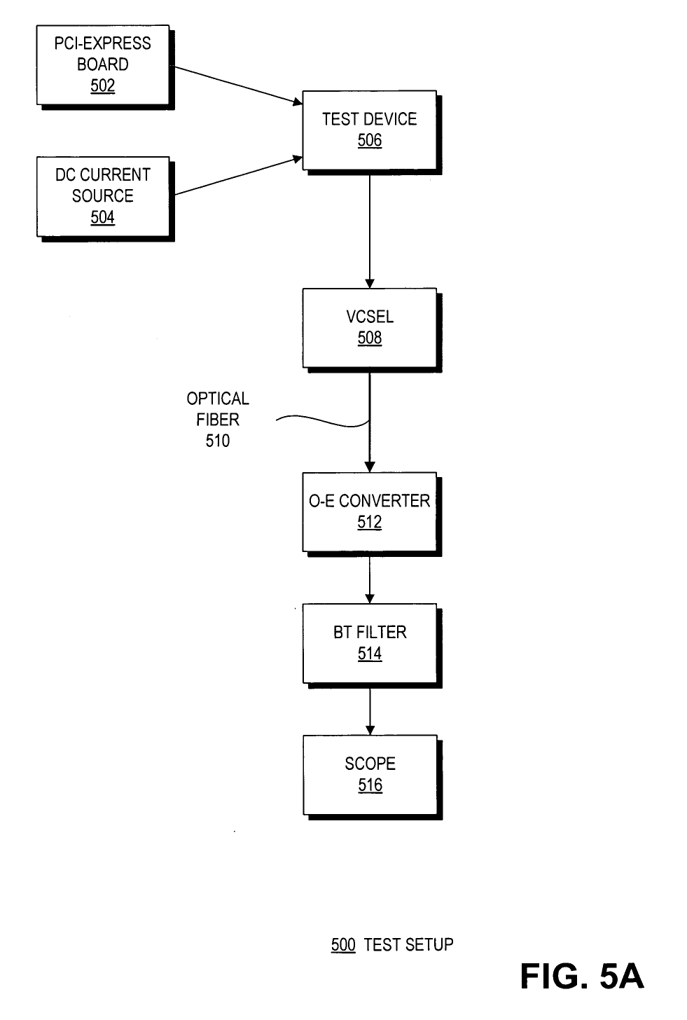

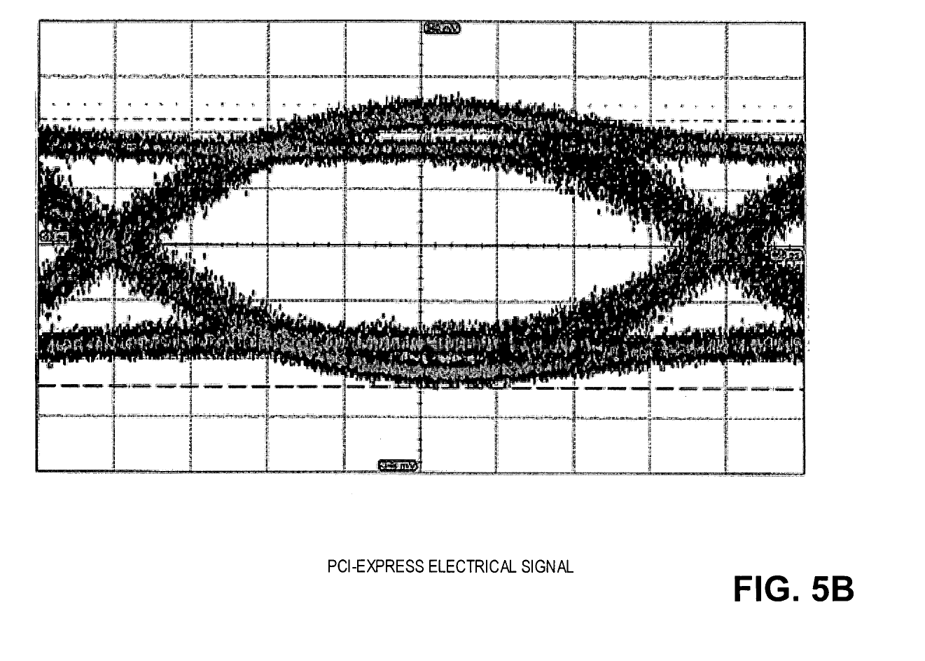

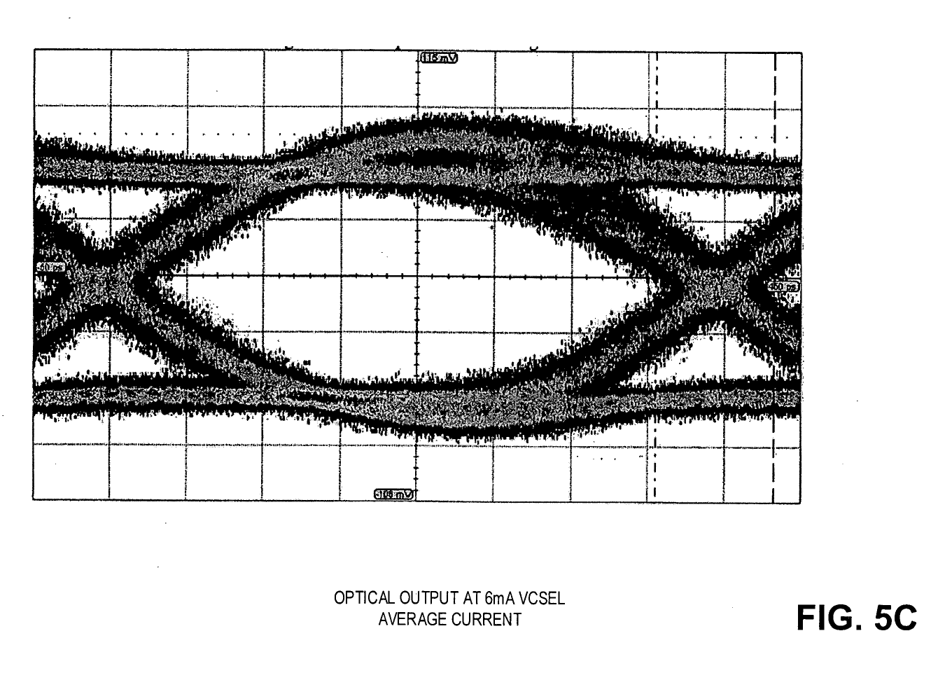

Referring to FIGS. 5A-5C, a test of an embodiment of the invention will be described. In FIG. 5A, a test setup 500 is shown. A PCIe board 502 and a DC current source 504 are coupled to a test device 506 that mimics AC coupling capacitor 306 and AC block 310 as shown in FIG. 3.

Test device 506 is coupled to VCSEL 508. An optical fiber 510 couples the optical output of VCSEL 508 to Optical-Electrical (O-E) converter 512. O-E converter 512 is coupled to a Bessel Thompson (BT) filter 514 that in turn is coupled to a scope 516.

FIG. 5B is an eye diagram of the PCIe electrical signal output by PCIe board 502. FIG. 5C is an eye diagram of the corresponding optical output of VCSEL 508. The eye diagram of FIG. 5C shows almost no increase in jitter or degradation in the eye pattern quality as compared to FIG. 5B.

The test conditions shown in FIGS. 5B and 5C were as follows. The bias current of the VCSEL was 6.0 milliamperes (mA). PCIe driver modulation current was set to the minimum value. PCIe pre-emphasis was on. A Pseudo-Random Bit Sequence Pattern 7 (PRBS7) was used in testing. The PCIe driver drove VCSEL 508 single ended with the negative terminal of the PCIe driver grounded.

FIG. 6 is an illustration of one embodiment of a computer system 600 that includes an electrical link driver to drive a laser in accordance with embodiments described herein. Embodiments of the present invention may also be used in other electronic devices such as a Digital Versatile Disk (DVD) player/recorder, a television, a set-top-box, a computer or video display, or the like. Embodiments may be used to connect components within such an electronic device, or to connect one electronic device to another, such as connecting a set-top-box to a television to provide high-speed video signals to the television.

Computer system 600 includes a processor 602 and a memory 604 coupled to a chipset 606. Storage 612, Non-Volatile Storage (NVS) 605, and network interface (I/F) 614, and Input/Output (I/O) device 618 may also be coupled to chipset 606. Embodiments of computer system 600 include, but are not limited to, a desktop computer, a notebook computer, a server, a personal digital assistant, a network workstation, or the like. In one embodiment, computer system 600 includes processor 602 coupled to memory 604, processor 602 to execute instructions stored in memory 604.

Processor 602 may include, but is not limited to, an Intel Corporation x86, Pentium®, Celeron®, or Itanium® family processor, or the like. In one embodiment, computer system 600 may include multiple processors. In another embodiment, processor 602 may include two or more processor cores.

Memory 604 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like. In one embodiment, memory 604 may include one or more memory units that do not have to be refreshed.

Chipset 606 may include a memory controller, such as a Memory Controller Hub (MCH), an input/output controller, such as an Input/Output Controller Hub (ICH), or the like. In an alternative embodiment, a memory controller for memory 604 may reside in the same chip as processor 602. Chipset 606 may also include system clock support, power management support, audio support, graphics support, or the like. In one embodiment, chipset 606 is coupled to a board that includes sockets for processor 602 and memory 604.

Components of computer system 600 may be connected by various interconnects. In one embodiment, an interconnect may be point-to-point between two components, while in other embodiments, an interconnect may connect more than two components. Such interconnects may include a Peripheral Component Interconnect (PCI), such as PCI Express, a System Management bus (SMBUS), a Low Pin Count (LPC) bus, a Serial Peripheral Interface (SPI) bus, an Accelerated Graphics Port (AGP) interface, or the like. I/O device 618 may include a keyboard, a mouse, a display, a printer, a scanner, or the like. Embodiments of a display may include a Cathode-Ray-Tube (CRT) display, a Liquid Crystal Display (LCD), a plasma display, or the like.

Computer system 600 may interface to external systems through network interface 614. Network interface 614 may include, but is not limited to, a modem, a Network Interface Card (NIC), or other interfaces for coupling a computer system to other computer systems. A carrier wave signal 623 may be received/transmitted by network interface 614. In the embodiment illustrated in FIG. 6, carrier wave signal 623 is used to interface computer system 600 with a network 624, such as a Local Area Network (LAN), a Wide Area Network (WAN), the Internet, or any combination thereof. In one embodiment, network 624 is further coupled to a computer system 625 such that computer system 600 and computer system 625 may communicate over network 624.

The computer system 600 also includes non-volatile storage 605 on which firmware and/or data may be stored. Non-volatile storage devices include, but are not limited to, Read-Only Memory (ROM), Flash memory, Erasable Programmable Read Only Memory (EPROM), Electronically Erasable Programmable Read Only Memory (EEPROM), Non-Volatile Random Access Memory (NVRAM), or the like. Storage 612 includes, but is not limited to, a magnetic hard disk drive, a magnetic tape drive, an optical disk drive, or the like. It is appreciated that instructions executable by processor 602 may reside in storage 612, memory 604, non-volatile storage 605, or may be transmitted or received via network interface 614.

Embodiments of computer system 600 may include an electrical link driver to drive a laser as described herein. For example, in FIG. 6, storage 612 may be coupled to chipset 606 by optical link 611. One or both transmission ends of optical link 611 may include an electrical link driver to drive an associated laser in accordance with embodiments herein. In one embodiment, the electrical link driver at chipset 606 may be an integrated part of chipset 606. In another embodiment, the electrical link driver may be included in a PCIe card that is residing in a PCIe slot.

In another example, an optical link 617 may connect chipset 606 to an external device 619. Embodiments of external device 619 include an external magnetic hard disk drive, an external optical drive, a display, a webcam, a scanner, or the like. One or both transmission ends of optical link 617 may include an electrical link driver to drive an associated laser in accordance with embodiments herein.

It will be appreciated that in one embodiment, computer system 600 may execute Operating System (OS) software. For example, one embodiment of the present invention utilizes Microsoft Windows® as the operating system for computer system 600. Other operating systems that may be used with computer system 600 include, but are not limited to, the Apple Macintosh operating system, the Linux operating system, the Unix operating system, or the like.

Various operations of embodiments of the present invention are described herein. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment of the invention.

The above description of illustrated embodiments of the invention, including what is described in the Abstract, is not intended to be exhaustive or to limit the embodiments to the precise forms disclosed. While specific embodiments of, and examples for, the invention are described herein for illustrative purposes, various equivalent modifications are possible, as those skilled in the relevant art will recognize. These modifications can be made to embodiments of the invention in light of the above detailed description. The terms used in the following claims should not be construed to limit the invention to the specific embodiments disclosed in the specification. Rather, the following claims are to be construed in accordance with established doctrines of claim interpretation.

What is claimed is:

1. An apparatus, comprising:
an electrical link driver for a point-to-point link; and
a laser coupled to the electrical link driver, the electrical link driver to provide a modulation current to the laser.

2. The apparatus of claim 2 wherein the electrical link driver includes one of a Peripheral Component Interconnect (PCI) Express driver or a Serial Advanced Technology Attachment (SATA) driver.

3. The apparatus of claim 1 wherein the laser includes a Vertical Cavity Surface Emitting Laser (VCSEL).

4. The apparatus of claim 1, further comprising an optical fiber optically coupled to the laser.

5. The apparatus of claim 1, further comprising a bias current source coupled to the laser to provide a bias current to the laser.

6. The apparatus of claim 5, further comprising an Alternating Current (AC) block coupled between the bias current source and the laser, wherein the bias current source includes a Direct Current (DC) current source.

7. The apparatus of claim 1 wherein the electrical link driver includes:
a positive voltage terminal coupled to an anode of the laser; and
a negative voltage terminal coupled to a cathode of the laser.

8. The apparatus of claim 7, further comprising a first AC coupling capacitor coupled between the positive voltage terminal and the anode of the laser.

9. The apparatus of claim 7, further comprising a second AC coupling capacitor coupled between the negative voltage terminal and the cathode of the laser.

10. The apparatus of claim 9, further comprising a termination resistor coupled between the second AC coupling capacitor of the cathode of the laser.

11. A method, comprising:
generating a modulation current for a point-to-point link, wherein the point-to-point link uses differential signaling;
generating a bias current; and
driving a semiconductor laser diode using the modulation current and the bias current.

12. The method of claim 11 wherein the modulation current is generated by an electrical link driver coupled to the semiconductor laser diode.

13. The method of claim 11 wherein the bias current is generated by a Direct Current (DC) current source coupled to the semiconductor laser diode.

14. The method of claim 13, further comprising isolating the modulation current from the DC current source.

15. The method of claim 11, further comprising adjusting the voltage of the modulation current to be compatible with a forward voltage of the semiconductor laser diode.

16. The method of claim 11, further comprising providing the electric link driver a balanced load.

17. The method of claim 11, further comprising optically coupling an optical output of the semiconductor laser diode to an optical waveguide.

18. A system, comprising:
a liquid crystal display; and
a chipset coupled to the liquid crystal display by a first optical link, the chipset including:
a first laser optically coupled to the first optical link; and
a first electrical link driver coupled to the first laser, the first electrical link driver to provide a modulation current to the first laser.

19. The system of claim 18, further comprising a magnetic disk drive coupled to the chipset by a second optical link, wherein the chipset includes:
a second laser optically coupled to the second optical link; and
a second electrical link driver coupled to the second laser, the second electrical link driver to provide a modulation current to the second laser.

20. The system of claim 18 wherein the first laser includes a Vertical Cavity Surface Emitting Laser (VCSEL).
